(19) United States
(12) Patent Application Publication
(10) Pub. No.: US 2007/0106499 A1
(43) Pub. Date: May 10, 2007

(54) NATURAL LANGUAGE SEARCH SYSTEM

(76) Inventors: Kathleen Dahlgren, Los Angeles, CA (US); Edward P. Stabler JR., Los Angeles, CA (US); Karen K. Wallace, Altadena, CA (US); Paul Deane, Lawrence Township, CA (US)

Correspondence Address: IRELL & MANELLA LLP, 1800 AVENUE OF THE STARS, SUITE 900, LOS ANGELES, CA, 90067, US

(21) Appl. No.: 11/463,296

(22) Filed: Aug. 8, 2006

Related U.S. Application Data
(60) Provisional application No. 60/707,013, filed on Aug. 9, 2005.

(51) Int. Cl. G06F 17/21

(52) U.S. Cl. 704/10

(57) ABSTRACT

A natural language system searching system develops concept and string indexes of a textual database, such as a group of litigation documents, by breaking the text to be indexed into sentences, words, dates, names and places in a reader, identifying phrases in a phrase parser, recovering word stems in a morphology module and determining the sense of potentially ambiguous words in a sense selector, all in accordance with words and concepts (word senses) stored in lexicon database 9-32. A query may then be processed by the reader, phrase parser, morphology module, and sense selector to provide a text meaning output which can be compared with the concept and string indexes to identify, retrieve and display documents and/or portions of documents related to the query. A lexicon enhancer adds vocabulary semi-automatically.

### RELATED APPLICATIONS

This application claims the priority of the filing date of U.S. Provisional application Ser. No. 60/707,013 filed Aug. 09, 2005;

### BACKGROUND OF THE INVENTION

1. Field of the Invention

This invention relates to natural language interpretation using a computer system and in particular to a search engine based on natural language interpretation.

2. Background Art

Communication with computer systems is accomplished with the use of binary code sequences (so called “machine language”) that the computer processor can interpret as instructions. It is difficult to communicate in binary code, so artificial programming languages have been created to make it easier to communicate with a computer system. A programming language for a computer system is a language that can be interpreted or translated into binary code or into a language that itself can ultimately be translated into binary code. Examples are “C”, “Basic”, “Pascal”, “Fortran”, etc. Artificial languages have strict rules of syntax, grammar, and vocabulary. Variations from the rules can result in error in communicating with the computer system.

The prior art has attempted to create new, so called “high level” artificial languages that are more like a “natural” language. A natural language is a language, such as English, used by humans to communicate with other humans. However, such high level artificial languages still include strict rules and limitations on vocabulary.

Other attempts have been made to provide a means to interpret communication in natural languages and provide translations of these communications to the computer system for processing. In this manner, a human user could communicate commands or requests to a computer system in English, and the communication could be translated into machine language for use by the computer system. Such attempts are referred to as computerized natural language understanding systems.

Computerized natural language understanding could be used to interpret a query that a user provides to the computer in a natural language (e.g., English). One area where the computerized ability to interpret language could be used is to retrieve text from a text retrieval system based on a human language query.

Conventional text retrieval systems store texts (i.e., a document base) and provide a means for specifying a query to retrieve the text from the document base. Prior art text retrieval systems use several types of approaches to provide a means for entering a query and for retrieving text from the document base based on the query.

One approach, a statistical approach, implements a keyword-based system. In this approach, Boolean (i.e., logical) expressions that consist of keywords are used in the query. This approach uses a directory that consists of keywords and the locations of the keywords in the document database. For example, this approach uses a query such as the following that consists of keywords delimited by Boolean operators (the keywords are italicized and the Boolean operators are capitalized):
(attack or change) AND (terrorist OR guerrilla) AND (base OR camp OR post)

The keywords input as part of the query are compared to the keywords contained in the directory. Once a match is found, each location contained in the directory that is associated with the matched keyword can be used to find the location of the text (i.e., keyword) in the document database.

Text retrieval systems are typically evaluated by two measures, precision and recall. Recall measures the ratio between the number of documents retrieved in response to a given query and the number of relevant documents in the database. Precision measures the ratio between the number of relevant documents retrieved and the total number of documents retrieved in response to a given query. Conventional research text retrieval systems perform poorly on both measures. The best research systems typically do not reach 40% precision and 40% recall. Thus there is typically built-in tradeoff between recall and precision in keyword-based systems. However, conventional techniques typically do not retrieve text based on the actual meaning and subject content of the documents, so that any texts using different words with the same meaning will not be retrieved. On the other hand, texts using the same words in different meanings will typically be erroneously retrieved.

Furthermore, the keyword-based approach (employed in conventional commercial systems) typically has a built-in tradeoff between precision and recall. When the keyword-based approach has good recall, precision is poor. On the other hand, when precision is good, recall is poor. Thus, when it has good recall, it retrieves many or all of the documents which are relevant to the query, but it also retrieves many others which are irrelevant, and the user has to waste time inspecting many unwanted documents. On the other hand, when precision is good, many of the relevant documents are not retrieved, so that the user cannot be confident that all or enough of the desired information has actually been retrieved and displayed in response to the query.

The reason for poor precision is that the keyword-based approach inspects only surface forms (words and their locations relative to each other in the text), and assumes that these surface features accurately reflect meaning and content. But words are ambiguous and mean different things in context.

For example, in the query above, the words “charge” and “attack” have many meanings, both as nouns and verbs, in English. Similarly, “base”, “camp” and “post” are ambiguous. In a document database, they can occur in many texts which have nothing to do with terrorist attacks. Here are some sample irrelevant texts which a keyword-based system would erroneously retrieve in response to the above query:

The ambassador suffered a heart attack directly after his speech at the army base denouncing the guerrillas.

The base commander charged the guerrilla group with treaty violations.

On the other hand, the reason for poor recall is typically that natural language affords literally thousands of ways of expressing the same concept or describing the same situation. Unless all of the words which could be used to describe the desired information are included in the query, all of the documents can't be retrieved. The reason poor recall systematically results in the context of good precision is that to the extent that the keyword-based system retrieves precisely, the query has enough keywords in it to exclude many of the irrelevant texts which would be retrieved with fewer keywords. But by the same token, and by the very nature of the technology, the addition of keywords excludes a good number of other retrievals which used different combinations of words to describe the situation relevant to the query. For example, the query above would typically miss relevant texts such as:

The guerrillas bombed the base. The guerrillas hit the base. The guerrillas exploded a bomb at the base. The terrorists bombed the base. The terrorists hit the base. The terrorists exploded a bomb at the base.

Conventional key word approaches have the further disadvantage of using a query language that consists of keywords separated by Boolean operators. A user has difficulty understanding this query structure. Further, it is difficult for a user to predict which words and phrases will actually be present in a relevant document.

Several improvements have been attempted for keyword-based approach. Examples of such improvements include the use of synonym classes, statistical ranking of texts, fuzzy logic, and concept clustering. However, none of these provide any significant improvement in the precision/recall tradeoff. Further, none of these approaches provides a solution to the difficulty with using a Boolean query language.

Another approach implements a semantic network to store word meanings. The basic idea is that the meaning of a word (or concept) is captured in its associated concepts. The meaning is represented as a totality of the nodes reached in a search of a semantic net of associations between concepts. Similarity of meaning is represented as convergence of associations. The network is a hierarchy with “isa” links between concepts. Each node is a word meaning or concept. By traversing down through a hierarchy, a word meaning (or concept) is decomposed.

For example, within one branch of a hierarchy, an ANIMAL node has a child node, BIRD, that has a child node entitled CANARY. This hierarchy decomposes the meaning of the ANIMAL concept into the BIRD concept which is further decomposed into a CANARY. Properties that define a concept exist at each node in the hierarchy. For example, within the ANIMAL branch of the hierarchy, the BIRD node has “has wings” and “can fly” properties. The CANARY node has “can sing” and “is yellow” properties. Further, a child node inherits the properties of its ancestor node(s). Thus, the BIRD node inherits the properties of the ANIMAL, and the CANARY node inherits the properties of the BIRD and ANIMAL nodes.

The semantic net idea is an important one in artificial intelligence and some version of a classification scheme is incorporated in all semantic representations for natural languages. However, in these prior versions, the classification scheme is: 1) not tied to the specific meanings (senses) of words, 2) not based upon psycholinguistic research findings, 3) not integrated with syntactic information about word senses, and 4) not deployed during parsing.

Furthermore, it has apparently been assumed, in prior approaches, that word meanings can be decomposed into a relatively small set of primitives, but it has been shown that lexical knowledge is not limited to a finite set of verbal primitives. Most importantly, no knowledge representation scheme for natural language, including any semantic net representation, has been able to overcome the apparent intractability of representing all of the concepts of a natural language. Small examples of semantic nets were created, but never a large enough one to provide the basis for a natural language system.

Another type of network approach, neural net, attempts to simulate the rapid results of cognitive processes by spreading the processing across a large number of nodes in a network. Many nodes are excited by the input, but some nodes are repeatedly excited, while others are only excited once or a few times. The most excited nodes are used in the interpretation. In the model, the input is repeatedly cycled through the network until it settles upon an interpretation.

This method substitutes the difficult problem of modeling human parsing on a computer with modeling language learning on a computer. Researchers have known and formalized the parsing rules of English and other natural languages for years. The problem has been the combinatorial explosion. This method provides no new insights into parsing strategies which would permit the efficient, feasible application of the rules on a computer once the system has automatically “learned” the rules. Nor has any such system as yet learned any significant number of rules of a natural language.

One conventional approach attempts to interpret language in a manner that more closely parallels the way a human interprets language. The traditional approach analyzes language at a number of levels, based on formal theories of how people understand language. For example, a sentence is analyzed to determine a syntactic structure for the sentence (i.e., the subject, verb and what words modify others). Then a dictionary is used to look up the words in the sentence to determine the different word senses for each word and then try to construct the meaning of the sentence. The sentence is also related to some knowledge of context to apply common sense understanding to interpret the sentence.

These approaches may create a combinatorial explosion of analyses. There are too many ways to analyze a sentence and too many possible meanings for the words in the sentence. Because of this combinatorial explosion, a simple sentence can take hours or days to process. Such conventional approaches have no means for blocking the combinatorial explosion of the analysis. Further, there is no adequate ability to reason about the feasible meaning of the sentence in context.

A natural language understanding system is shown in U.S. Pat. No. 5,974,050, issued Aug. 11, 1998 to one of the inventors herein provided a substantial improvement over approaches that were convention when the application was first filed in 1995. What are needed are further improvements in natural language understanding systems.

### BRIEF DESCRIPTION OF THE DRAWINGS

FIGS. 1-8 illustrate the prior embodiment shown in U.S. Pat. No. 5,974,050.

FIG. 1 illustrates a general purpose computer for implementing the present invention.

FIG. 2 provides an overview of a text retrieval system that uses the natural language understanding capabilities of the present invention.

FIG. 3 illustrates a model generation and information classification architecture.

FIG. 4 provides an illustration of a Text Retrieval Architecture.

FIG. 5 provides an overview of the NLU module.

FIGS. 6A-6B provide examples of a Discourse Representation Structure.

FIG. 7 illustrates an ontology that can be used to classify word senses in the English language.

FIG. 8 illustrates a dictionary entry used in the prior embodiment.

FIGS. 9-15 illustrate a system overview of the improved NLU and system.

FIG. 9a provides an overview schematic of the modules of the improved natural language processor used as a query processing or indexing processing engine.

FIG. 9b provides an overview schematic of the query and indexing module combined to provide a search engine.

FIG. 10 is an overview schematic of Word Reader 9-14.

FIG. 11 is an overview schematic of Phrase Parser 9-16.

FIG. 12 is an overview schematic of Morphology module 9-18.

FIGS. 13 and b are an overview schematic of Meaning context database 9-34 and Sense selector 9-20.

FIG. 14 is an overview schematic of hypemym and synonym analyzer 9-24.

FIG. 15 is an overview schematic of a semantic database updating technique.

### SUMMARY OF THE INVENTION

A database of documents may be searched by providing a natural language understanding (NLU) module which parses text and disambiguates concepts, processing documents in a database with the NLU module to generate cognitive models of each of documents and a searchable index of the cognitive models in a predetermined format indicating the possible, non-ambiguous meanings of the concepts together with synonyms and hypernyms of the concepts by selection from a precompiled static dictionary and ontology database, processing a query with the NLU module to generate a cognitive model of the query in the predetermined format without synonyms and hypernyms, comparing the cognitive model of the query with the searchable index to select the documents likely to be relevant to the query and comparing the cognitive model of the query with the full text of the selected documents to select the documents to include in a response to the query.

### DETAILED DESCRIPTION OF THE PREFERRED EMBODIMENTS

A natural language search engine provides the ability for a computer system to interpret natural language input. It can reduce or avoid the combinatorial explosion that has been typically been an obstacle to natural language interpretation. Further, common sense knowledge (or world knowledge) can be used to further interpret natural language input.

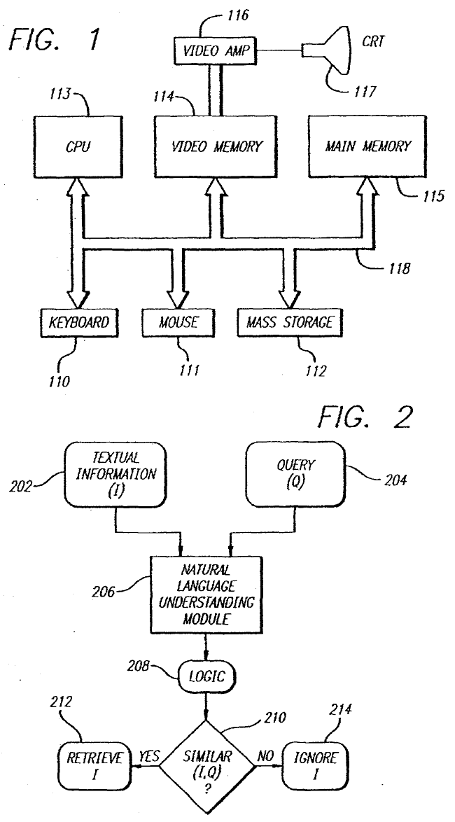

Referring now to FIGS. 1-8, in a prior embodiment disclosed in U.S. Pat. No. 5,794,050, a search engine may include modules for parsing, disambiguation, formal semantics, anaphora resolution and coherence, and a naive semantic lexicon to interpret natural language input. The naive semantic lexicon may consulted by the other modules to determine whether an interpretation alternative is plausible, that is, whether the interpretation alternative makes sense based on the world knowledge contained in the naive semantic lexicon. By eliminating the implausible alternatives at each decision point in the interpretation, the potentially unlimited combinations of alternatives may be eliminated thereby avoiding the combinatorial explosion that has occurred in past attempts at natural language interpretation.

The use of naive semantics may be crucial at all levels of analysis, beginning with the syntax, where it may be used at every structure building step to avoid combinatorial explosion. One key idea is that people rely on superficial, commonsense knowledge when they speak or write. That means that understanding should not involve complex deductions or sophisticated analysis of the world, but just what is immediately “obvious” or “natural” to assume. This knowledge often involves assumptions (sometimes “naive” assumptions) about the world, and about the context of the discourse.

A naive semantic ontology may be used as a sophisticated semantic net. The ontology may provide a technique for classifying basic concepts and interrelationships between concepts. The classification system may provide psychologically motivated divisions of the world. A dictionary (lexicon) may relate word senses to the basic ontological concepts and specifies common sense knowledge for each word sense. The dictionary may connect syntactic information with the meaning of a word sense. The lexicon may provide advantages from its integration of syntactic facts, ontological information and the commonsense knowledge for each sense of each word.

Text retrieval provides one application of the natural language interpretation in a computer. Feasible text retrieval may be based on the “understanding” of both the text to be retrieved and the request to retrieve text (i.e., query). The “understanding” of the text and the query involve the computation of structural and semantic representations based on morphological, syntactic, semantic, and discourse analysis using real-world common sense knowledge.

The interpretative capabilities of the search engine may be used in two separate processes. The first process uses a natural language understanding (NLU) module to “digest” text stored in a full text storage and generate a cognitive model. The cognitive model may be in first order logic (FOL) form. An index to the concepts in the cognitive model may also generated, so that the concepts can be located in the original full text for display.

A second process may interpret a query and retrieves relevant material from the full text storage for review by the requester. The NLU module may be used to generate a cognitive model of a text retrieval request (i.e., query). The cognitive model of the text and the cognitive model of the query may be compared to identify similar concepts in each. Where a similar concept is found, the text associated with the concept may be retrieved. Two passes (i.e., a high recall statistical pass and a relevance reasoning pass) may be used to generate a short list of documents that are relevant to the query. The short list may then ranked in order of relevance and displayed to the user. The user may select texts and browses them in a display window.

A Natural Language Interpretation System is described. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Referring now to FIG. 1, a first embodiment is shown in which the search engine may be implemented on a general purpose computer. A keyboard 110 and mouse 111 may be coupled to a bi-directional system bus 118. The keyboard and mouse may be used for introducing user input to the computer system and communicating that user input to CPU 113. The computer system of FIG. 1 may also include a video memory 114, main memory 115 and mass storage 112, all coupled to bi-directional system bus 118 along with keyboard 110, mouse 111 and CPU 113. The mass storage 112 may include both fixed and removable media, such as magnetic, optical or magnetic optical storage systems or any other available mass storage technology. Bus 118 may contain, for example, 32 address lines for addressing video memory 114 or main memory 115. The system bus 118 may also include, for example, a 32-bit DATA bus for transferring DATA between and among the components, such as CPU 113, main memory 115, video memory 114 and mass storage 112. Alternatively, multiplex DATA/address lines may be used instead of separate DATA and address lines.

The CPU 113 may be a 32-bit microprocessor manufactured by Motorola, such as the 680X0 processor or a microprocessor manufactured by Intel, such as the 80X86, or Pentium processor. However, any other suitable microprocessor or microcomputer may be utilized. Main memory 115 may include dynamic random access memory (DRAM). Video memory 114 may be a dual-ported video random access memory. One port of the video memory 114 may be coupled to video amplifier 116. The video amplifier 116 may be used to drive the cathode ray tube (CRT) raster monitor 117. Video amplifier 116 is well known in the art and may be implemented by any suitable means. This circuitry converts pixel DATA stored in video memory 114 to a raster signal suitable for use by monitor 117. Monitor 117 may be a type of monitor suitable for displaying graphic images.

The computer system described above is for purposes of example only. The present invention may be implemented in any type of computer system or programming or processing environment.

The natural language unit (NLU) is described below in relation to a text retrieval system. However, the NLU can be used with other applications to provide a human interface between the computer and the user or simulate human language interpretation. For example, the NLU can be used to automatically understand and interpret a book and generate an abstract for the book without human intervention. The NLU can be used to provide an interface to the Worldwide Web and the Information Highway.

Further, the NLU can be used to develop a natural language interface to a computer system such that a user can command a computer, robot, or write computer programs in a natural language. The NLU can be used to provide the ability for a robot to behave independently on the basis of world knowledge. Computers with NLU capabilities can begin to learn the environment just as a child does.

Natural Language Understanding

The prior embodiment understands a natural language (e.g., English) in a way which is similar to human understanding. A natural language is both highly ambiguous (the same pattern can mean many different things), and redundant (the same meaning can be expressed with many different patterns). The prior embodiment uses a Natural Language Understanding (NLU) module to analyze this complex structure, and unravel its meaning layer by layer. The NLU module receives a natural language input and generates a first order logic (FOL) output.

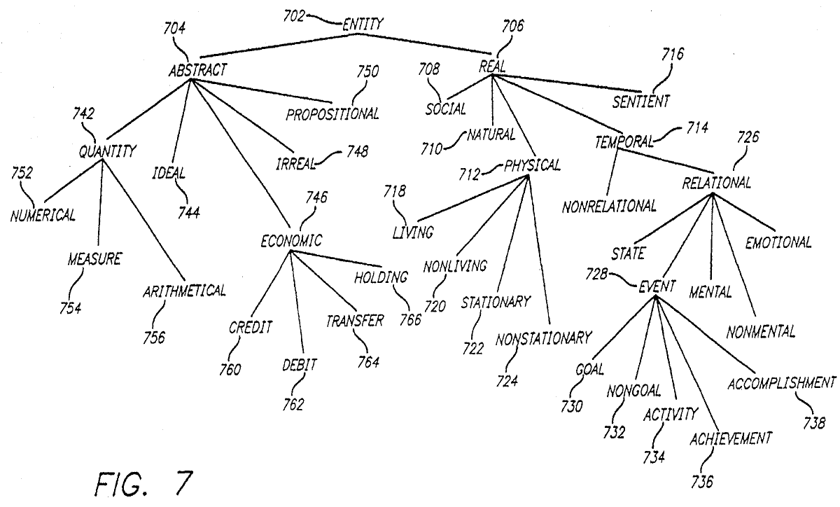

Referring now in particular to FIG. 5, the NLU module may block the combinatorial explosion that has occurred in the prior attempts to parse and understand natural language on a computer. The combinatorial explosion results from the many possible structures and meanings that can be given to words and phrases in a natural language. Further, the NLU module may avoid the intractability of common sense reasoning.

Parser 502 analyzes the grammatical parts of a natural language sentence or discourse and their roles relative to each other. For example, parser 502 identifies the noun, verb, etc. and determines what phrases modify what other portions (e.g., noun phrase or verb phrase) of the sentence.

In the prior embodiment, a left-corner head-driven parsing strategy is used. This parsing strategy mixes a top-down syntactic analysis strategy with a bottom-up syntactic analysis strategy. In a bottom-up strategy, the syntactic analysis may be driven by the data (e.g., words or phrases) that is currently being processed. In a top-down strategy, the analysis may be driven by expectations of what the data must be in order to conform to what is already known from the data previously processed. The advantage of this approach is that you can have some expectations about what has not yet been heard (parsed) and can allow the expectations to be tempered (bottom up) by what is actually being heard (parsed). This strategy preserves some of the advantages of a top-down analysis (reducing memory requirements, integrating structure early in the analysis), while still avoiding some of the indeterminacy of a purely top-down analysis.

The mixed parsing strategy just described still faces a combinatorial explosion. Some of this comes from the indeterminacy just noted. That problem can be avoided by memorizing completed parts of the structure.

The disambiguation module 504 may be embedded into the parser to avoid the extra work of pursuing unlikely parse pathways. As each structure is built, a naive semantic lexicon 512 may be consulted to determine the semantic and pragmatic plausibility of each parsing structure. The naive semantic lexicon 512 may contain a knowledge base that identifies word senses that fit within the context of the input being parsed.

The disambiguation module 504 may eliminate structural and word sense ambiguity. Structural ambiguity may be introduced in at least four ways: noun-verb ambiguity, prepositional phrases, conjunctions, and noun-noun combinations.

Many words have a noun-verb ambiguity and this ambiguity may be a major source of the combinatorial explosion. Using naive semantic reasoning, the NLU selects the most plausible part of speech for such ambiguous words. For example, the following sentence contains ambiguities:

Face Places with Arms Down.

The words “face”, “places” and “arm” in this sentence can be either a noun or a verb. The two words “face places” could form: 1) a noun-noun combination meaning “places for faces”; 2) a noun-verb combination with “face” meaning “pride” as in “save face”, and place meaning the verb to “locate in a social status hierarchy; or 3) a verb-noun combination with “face” meaning command to place one's body with the one's face towards something and “places” a noun meaning seating positions at a table.

The NLU is able to select the third option as the most plausible interpretation for the phrase and the most plausible part of speech for each word in context. It selects a verb for “face” and a noun for “places” and “arms” in context because disambiguation reasoning finds that “with arms down” is a plausible modifying phrase for the verb “face” in the sense of position one's body. That choice carries with it the choice that “places” is a noun because noun for “places” is the only possibility if “face” is a verb.

Sentences with prepositional phrases after the object of the verb are ambiguous, because the first prepositional phrase after the object can modify the object, the verb, or the sentence constituent. The prior embodiment provides a computational method for prepositional phrase disambiguation using preposition-specific rules, syntax and naive semantics. This is further described below under “Naive Semantic Reasoning”.

Conjunctions (e.g., “and”, “but”, “as”, and “because”) serve to connect words, phrases, clauses, or sentences, for example. Conjoined noun phrases and verb phrases create a number of possible interpretations.

For example, in the sentence

The battery and line charged.

only one or two interpretations are plausible. However, the combinations of potential noun senses of “battery” and “line” and verb senses of “charge” amounts to 7*13*8 or 728 interpretations. Using the naive semantic lexicon 512, the disambiguation module 504 first reasons that only a few combinations of the two nouns “battery” and “line” are plausible. Two of the pairs are: 1) a battery of soldiers and a line of soldiers; and 2) the electrical device and the wire. Then, upon considering these pairs as subject of the verb “charge”, the disambiguation module 504 selects the pair meaning soldiers, because the naive semantic lexicon 512 has sufficient common sense knowledge to exclude and reject “line” as subject of “charge”. The appropriate meaning of “charge” does not accept a kind of wire as subject.

Noun-noun combinations such as “guerrilla attack” or “harbor attack” combine two or more nouns. These two examples, however, illustrate that each combination can create different meanings to the word “attack”. For example, in the noun-noun combinations “guerrilla attack” and “harbor attack”, “guerrilla” is the underlying subject of a sentence in which guerrillas attack and “harbor” is the object of the attack and the agent is not expressed. Naive semantic reasoning may be used to disambiguate noun-noun combinations.

The other type of ambiguity is word sense ambiguity. Word sense ambiguity stems from the many possible meanings that a natural language places on each word in the language. The actual meaning may be determined based on its use in a sentence and the meanings given to the other words during the interpretation process. To disambiguate a word, the prior embodiment first uses syntactic clues. Then the prior embodiment consults the naive semantic lexicon 512 to determine whether a possible sense of a word is reasonable given its context in the input being interpreted.

In the Formal Semantics module 506, the meaning of the natural language input is represented in a formal mathematical, logical language. The formal semantics module 506 translates natural language input into a logical form such as first order logical form.

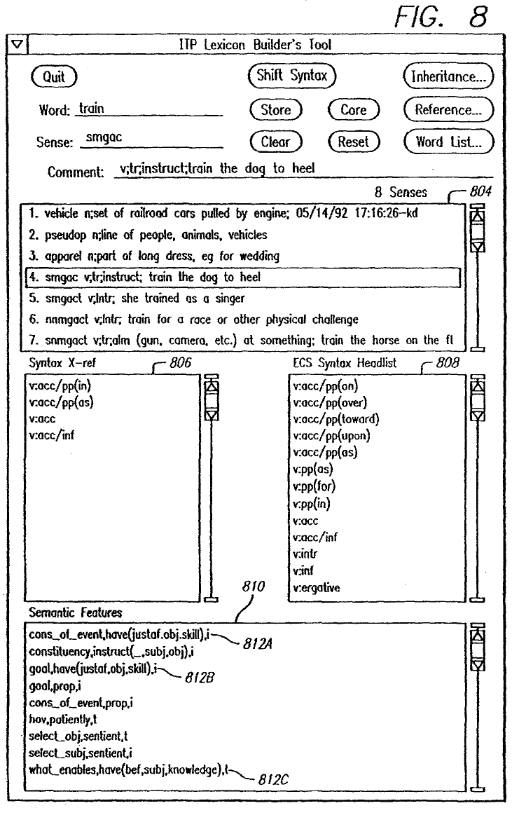

Referring now also in particular to FIG. 6, in the formal semantics module 506, a sentence or discourse may be translated into a discourse representation structure (DRS). In sentential semantic translation, a sentence may be translated into a sentence-specific DRS and incorporates the effects of operators, such as negation, which can alter the interpretation. The sentence-specific DRS may then added to the overall DRS in discourse semantic translation. FIG. 6 provides an example of a DRS for a first sentence of a discourse:
“The base was attacked by the guerrillas today.”

The DRS of FIG. 6 contains a list of indexed entities 604 that identify objects and events in the above sentence. For example, “e1” is the event of “attacking” and “the1” and “the2” represent the “guerrilla” and “base2” entities, respectively. The DRS further contains first-order representations 604, 606, 608, and 610 that depict properties and relations expressed in the sentence. For example, representation 604 indicates that event “e1” (i.e., attacking) is the event in which “the1(“guerrilla”) relates to entity “the2” (i.e., “base2”) in an attacking event in which “the1” is the attacker and “the2” is the attackee. Representation 610 indicates that event “e1” occurred “today”. Notice that words are replaced by concepts: “attack3” is the physical attack concept expressed by the “word attack” and “base2” is the concept of a military base.

The formal semantics module 506 generates output (e.g., DRS) that conveys the truth-conditional properties of a sentence or discourse. That is, the truths or negatives that are meant to be believed by the communication of the sentence or discourse. Later, when the system interprets a query and tries to retrieve texts which are relevant to the query, the relevance reasoning module 412 may be used deductively to determine whether the truth conditions asserted in the sentence or discourse conform to the truth conditions contained in a query. In other words, using deduction, the relevance reasoning module 412 may determine whether the world of some text in the document database conforms to the world of the query. The use of deduction makes this computation feasible and speedy.

A DRS may be translatable into FOL. The FOL may be then preferably translated into a programming language such as PROLOG, or a computational knowledge base. By translating the FOL into a programming language, standard programming methods can be applied in the relevance reasoning module 412.

Translation to a “logical form” suitable for reasoning, and also into discourse structures may be appropriate for determining the possible antecedents of anaphors and descriptions. The published “discourse representation theory” (DRT) model and structures of Kamp and Asher were adapted for use in the prior embodiment.

In the anaphora resolution module 508, entities are tracked and equated as they are mentioned in a sentence or discourse. Anaphora resolution module 508 links pronouns (e.g., he, she, and they) and the noun to which they refer. For example, the following provides an illustration of a discourse that includes the sentence previously illustrated (sentence S1) and a second sentence (S2):
S1: “The base was attacked by guerrillas today.”
S2: “They charged the outpost at dawn.”

FIG. 6B illustrates a modified DRS that includes sentences S1 and S2 of the discourse. With the addition of sentence S2 in the discourse, additional objects and events are added to representation 602. For example, “they1” is added to refer to the object “they”, “e2” to refer to the verb “charged”, “the3” to refer to “outpost” and g1 to refer to “dawn”. First Order representations 612, 614, 616, 618, and 620 are added for this sentence. The anaphora resolution module 508, for example, resolves the occurrence of “they” in the second sentence and equates it to “the1” (i.e., guerrillas) in representation 620. The naive semantic reasoning module 512 is consulted to determine whether guerrillas would charge an outpost as stated in sentence S2, for example.

The coherence module 510 determines the parts of the sentence or discourse that cohere or relate. The coherence module 510 determines the relationships that exist in the natural language input. For example, the coherence module 510 identifies a causal relationship. A causal relationship may exist, for example, in text such that a first portion of text provides the cause of something that occurs later in the text. Another relationship is an exemplification relationship. Such a relationship exists between two text segments where one further provides an example of the other. Goal and enablement are other examples of relationships that can be recognized by the coherence module 510.

The coherence module 510 builds a coherent model of a “world” based on the interpretation of the natural language input. The coherence module 510 uses the naive semantic reasoning module 512 to determine whether a coherence alternative is plausible. Using sentences S1 and S2 in the previous discourse illustration, for example, an inference can be made that “e1” (“attacked”) and “e2” (“charged”) cohere such that event “e2” occurred as part of event “e1”. That is, the act of charging occurred during the attacking event. Thus, the naive semantic reasoning module 512 can be used to determine that one event is broader than the other such that the latter occurred as part of the former. The present embodiment identifies a subevent of another event as a “constituency”. Using the same discourse illustration, the charging event (“e2”) is a constituent of the attack event (“e1) is represented as:
“constituency (e1, e2)”
   Naive Semantic Reasoning

As indicated above, the naive semantic lexicon 512 is consulted in the parser module 502, disambiguation module 504, formal semantics module 506, anaphora resolution module 508, and the coherence module 510 to bring common sense or world knowledge to bear in the decisions on structure and meaning made by a module. The naive semantic lexicon module 512 provides knowledge that is used to allow the NLU module to reason about the likely situation to which the words in a natural language input might be referring.

To eliminate the combinatorial explosion, the naive semantic lexicon 512 is consulted during each segment of the NLU module. In the parser 502, for example, the naive semantic lexicon 512 is consulted whenever parser 502 wishes to make a structural assumption about the natural language input (e.g., to connect a phrase or word to another phrase or word). At each of these decision points, the disambiguation module 504 consults the naive semantic lexicon 512 to assist in determining whether a disambiguation alternative is plausible.

The naive semantic lexicon 512 brings common sense (world knowledge) to bear on the interpretation performed by the NLU module. Common sense provides the ability to eliminate implausible or nonsensical structures or interpretations of the natural language input. The following two sentences serve to illustrate how common sense can be used during interpretation:
“John bought the lock with the money.”
“John bought the lock with the key.”

To interpret the first sentence, one possible alternative is to connect the prepositional phrase “with the money” to the verb “bought.” Another possible alternative is that the phrase “with the money” modifies “lock”. When a person hears this sentence, he knows that a lock does not normally come packaged with money. He can, therefore, apply common sense to rule out the second alternative. Based on his common sense, he can determine the meaning of the first sentence to be that someone paid cash to purchase a lock.

Further, while there are several meanings for the word lock (e.g., a security device or an enclosed part of a canal), a person can again apply common sense to select the meaning of the word that would most likely be the intended meaning. In this case, the person would pick the meaning that is most common (i.e., a security device). Therefore, the person uses common sense to interpret the sentence to mean that someone named John paid cash to purchase a security device.

Similarly, an individual can use common sense to connect words and phrases in the second sentence. In this case, the individual's prior knowledge would indicate that a lock is usually not bought using a key as tender. Instead, the individual would connect the “lock” and “with a key”. A common sense meaning of a security device can be assigned to the word “key”. Thus, the sentence is interpreted to mean that someone named “John” purchased both a security device and a key that can unlock this device.

A person's knowledge base provides the criteria used to interpret the world. In the usual case, a shallow layer of knowledge about an object or event, for example, is accessed by a person during language interpretation, as has been shown in psycholinguistic research studies of human language interpretation. This shallow layer of knowledge is the knowledge that is most likely to be true most of the time or is believed to be most likely. The term “naive” of naive semantics indicates that the knowledge required to understand language is not scientific and may not be true. The naive semantic lexicon is not intended to incorporate all knowledge or all of science. Rather, the naive semantic lexicon is intended to incorporate the same shallow level of knowledge used by a person to interpret language. By making the knowledge probabilistic, the prior embodiment did not have to consider possible interpretations that are implausible (or false in the typical case).

The naive semantic lexicon may have two aspects: ontology and description. In the ontology, a concept may be classified within a classification scheme. The descriptive aspect of the naive semantic lexicon identifies properties (e.g., shape, size, function) of a concept (or phrase).

The prior embodiment uses a classification scheme referred to as a “naive semantic ontology”. The naive semantic ontology is described in Dahlgren, Naive Semantics for Natural Language Understanding, (Kluwer Academic Publishers 1988) and is incorporated herein by reference. The naive semantic ontology provides a representation for basic concepts and interrelations. Using the ontology, objects and events may be sorted into major categories. The ontology reflects a common sense view (naive view) of the structure of the actual world. It encodes the major category cuts of the environment recognized by the natural language that it models, and is based upon scientific findings in cognitive psychology.

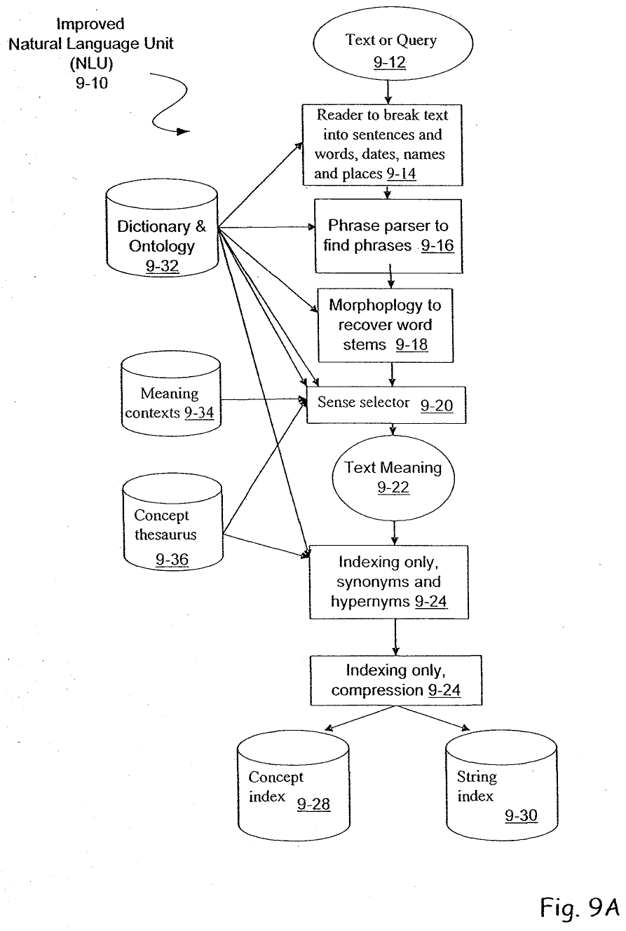

FIG. 7 illustrates an ontology that can be used to classify nouns in the English language. Entity 702 includes the Abstract 704 and Real 706 sub-classifications. Thus, an entity can be either abstract or real, for example. If the entity is classified under Real 706, the entity can be further classified as Social 708, Natural 710, Physical 712, Temporal 714, or Sentient 716, for example.

An entity that is classified as Real 706 and Physical 712, is further classified as either Living 718, Nonliving 720, Stationary 722, or Nonstationary 724, for example. To further illustrate, an event is classified as an Entity 702, Temporal 714, Relational 726, and Event 728. Event 728 has sub-classifications Goal 730, Nongoal 732, Activity 734, Achievement 736, and Accomplishment 738, for example, that can be used to further classify an event.

Using the ontological classification illustrated by FIG. 7, an entity can also be classified as Abstract 704. Within the Abstract 704 sub-classification, there is a Quantity 742, Ideal 744, Economic 746, Irreal 748, and Propositional 750 sub-classification. An entity that is classified as Abstract 740 and as a Quantity 742 can be further classified as either Numerical 752, Measure 754, or Arithmetical 756. Similarly, an abstract entity can be classified as Economic 746 and then within either a Credit 760, Debit 762, Transfer 764, or Holding 766 sub-classification, for example.

Other ontological classifications can also be used to further identify classifications for a knowledge base. Multiple ontological classifications can be used to further emulate human knowledge and reasoning. A human may cross-classify a natural language concept. Thus, for example, an entity may be classified as either Social 708 or Natural 710 using the ontology illustrated in FIG. 7. Further, the same entity may be classified as either Physical 712, Sentient 716, or Temporal 714. A Social 708, Sentient 716 is a “secretary”; a Social 708, Physical 712 is a “wrench”; and a Social 708, Temporal 714 is a “party”. On the other hand a Natural 710, Sentient 716 is a “person”; a Natural 710, Physical 712 is a “rock”; and a Natural 710, Temporal 714 is an “earthquake”. The ontology assumes instantiations may be multiply attached to classifications within an ontology. Thus, for example a person may be classified as Physical 712 and Living 718 as well as Sentient 716.

The lexicon 512 relates words in a natural language to the basic ontological concepts. The lexicon connects syntactic information (e.g., noun or verb) with the meaning of a word sense. The lexicon further specifies additional word-specific common sense knowledge. The lexicon specifically relates the syntactic context of each word to the possible meanings that the word can have in each context.

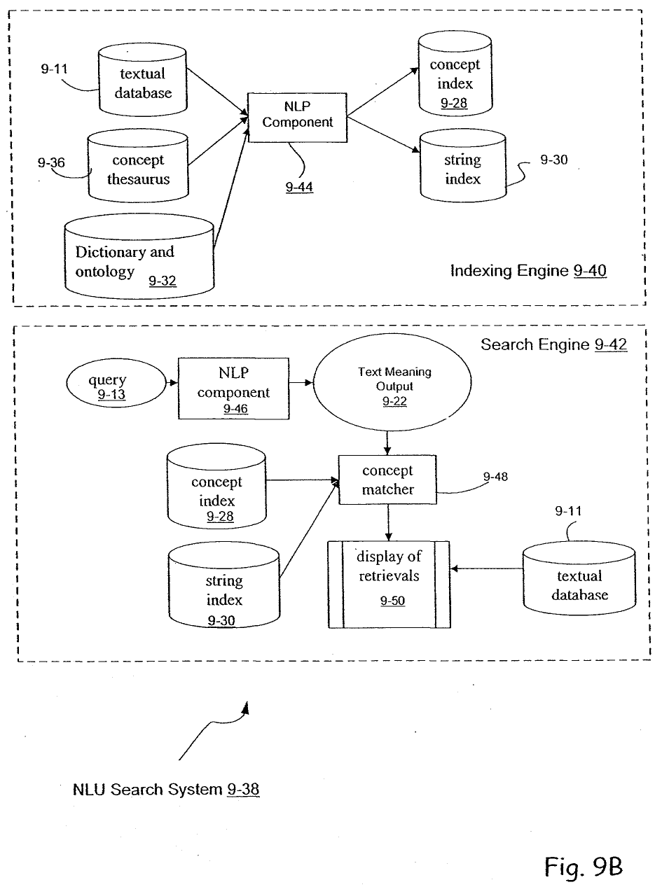

FIG. 8 illustrates a dictionary entry used in the prior embodiment. As indicated in the header portion 802 of the dictionary entry, the entry contains information about the word “train”. The word “train” can be, for example, a noun or a verb. In the sense portion 804 of the dictionary entry, there are seven different senses of the word train (numbered one to seven). Each entry in the sense portion 804 (“1”-“7”) identifies a common sense use for the word “train”. Further, each sense identifies the ontological attachment. Each sense has syntactic information and semantic properties associated with it.

For example, entry “4” in sense portion 804 identifies a word sense that means “instruct” such as to “train a dog to heel”. The “smgac” identifier in entry “4” links this meaning of “train” to a node in the ontological scheme. Sense portion 804 contains other senses of the word “train” including “set of railroad cars pulled by engine” (noun, entry “1”), “line of people, animals, vehicles” (noun, entry “2”), “part of long dress, e.g. for wedding” (noun, entry “3”), and “she trained as a singer” (verb, entry “5”).

An entry further includes syntactic information. Entry “4” has syntactic properties as indicated in syntactic portions 806 and 808. Syntactic portion 806 indicates that the sense of the word “train” identified by entry “4” in sense portion 804 is a verb that takes an accusative object with a prepositional phrase beginning with the word “in”, for example. Other syntactic features are identified in syntactic portion 806. For example, sense entry “4” of sense portion 804 can be a verb with an accusative object and an infinitival (e.g., train someone to . . . ).

A dictionary entry may further include semantic features. The semantic features portion 810 can, for example, provide coherence information that can be used to form relationships such as those formed in the coherence module 510. For example, in entry 812A, the consequence of the training event is identified. That is, for example, the consequence of the training event is that the entity trained has a skill. Further, as indicated in entry 812B, the goal of being trained is to have a skill. As indicated in entry 812C, knowledge is what enables one to train.

To understand and interpret input, people use any number of different concepts. People are not limited to a finite number of primitive concepts from which all other concepts are generated. Therefore, lexicon 512 includes entries that represent natural language concepts that can themselves be represented in terms of the other concepts, in much the same way as people formulate concepts. In the prior embodiment, concepts did not have to be represented in a language consisting only of primitives. In the prior embodiment, an open-ended number of different concepts could occur as feature values.

Referring now to FIG. 8. the semantic features portion 810 contains semantic feature values (e.g., entries 812A-812C) that represent natural language concepts. Preferably, these feature values are expressed in FOL for ease of deductive reasoning. Each semantic feature value can contain elements that are part of the representation language and also elements which are other concepts of natural language.

For example, “cons.sub.-- of.sub.-- event” in entry 812A and “goal” in 812B maybe examples of elements of a representation language. The feature values “knowledge” (in feature entry 812C) and “skill” (in feature entry 812B) are not elements of the representation language. Rather, they are themselves natural language concepts. The “knowledge” and “skill” concepts may each have a separate entry in the dictionary (or lexicon).

Preferably, the dictionary information may be represented in data structures for access during processing. For example, the basic ontological information may be encoded in simple arrays for fast access. Further, propositional commonsense knowledge may be represented in first order logic (an extension of “Horn clause” logic) for fast deductive methods.

The tasks performed by modules 502, 504, 506, 508, 510, and 512 can be performed serially or in parallel. In the prior embodiment, the tasks are performed in parallel. Using parallel processing, the interpretation processes performed by these modules can be performed faster.

The naive semantic lexicon may include at least the following properties: 1) psychologically-motivated representations of human concepts (see senses 804, syntax 806, and semantic features 810); 2) shallow, superficial common sense knowledge (see semantic features 810); 3) knowledge is open-ended and can contain other concepts as well as elements of a representation language (see semantic features 810); 4) concepts are tied to natural language word senses (see senses 804); 5) concepts are tied to syntactic properties of word senses (see syntax 806); and 6) feature values are expressed in FOL for ease of deductive reasoning (see semantic features 810).

Natural Language Text Interpretation and Retrieval

As previously indicated, the prior embodiment can be used to provide a computerized system for retrieving text from a document database in response to a human language query. For example, the user describes a topic, or question, in a human language (e.g., English). The system displays a list of relevant documents by title in response to the query. An indication of the perceived relevancy of each title is also indicated. The user can use this indication to determine the viewing order of the returned documents. The user selects a document to browse by selecting its title. Once the user selects a document, the document is displayed in a scrollable window with the relevant sections highlighted.

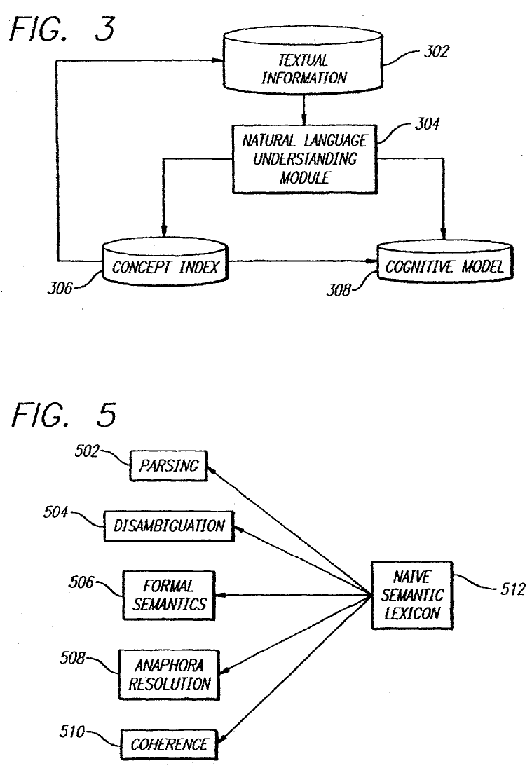

A document retrieval system such as the one just described comprises two distinct tasks: digestion and search. Both tasks use the natural language interpretation capabilities of the present invention. FIG. 2 provides an overview of a text retrieval system that uses the natural language interpretation capabilities of the present invention. At step 202, Textual Information is input to the Natural Language Understanding (NLU) module, and at step 206 the NLU module generates a cognitive model of the input text 202. The cognitive model 208 is in the form of FOL. Cognitive model 208 contains inferences from what the text says directly and is based upon inferences from the world knowledge.

Once a cognitive model is generated for the document database, a search request can be used to specify the search criteria. The document(s) that satisfy the search criteria are then retrieved for review by the user. Thus, at step 204, a query is input. The NLU module is used to generate a cognitive model of the search request at step 208. At decision step 210 (i.e., “Similar (I,Q)?), the cognitive model of the search request is matched to the cognitive model of each document in the database. If they are similar, the information is retrieved at step 212. If they are not, the information is not retrieved at step 214. Steps 210, 212, and 214 can be repeated while there are still documents to compare against the search request or the search is aborted, for example.

The process of digesting the information input at step 202 may be performed independently of the process of understanding the search request input at step 204. The process of digesting the information can, therefore, be performed in a batch mode during non-peak time (i.e., the time that the system is normally used for text retrieval). The process of understanding the search request and retrieving the text can be performed any time that a user wishes to perform a search. By separating the resource-intensive digestion of the information from a search request and information retrieval, a timely response to a search request can be provided to the user.

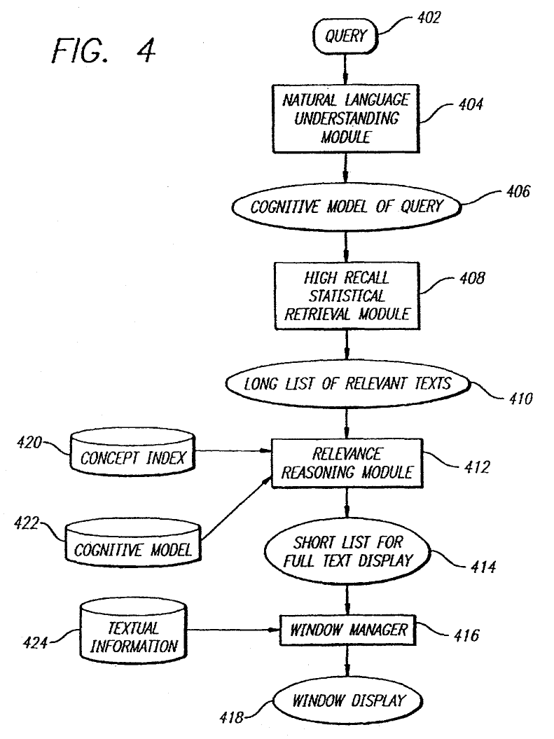

The first of the two independent processes, the process of digesting information, uses the NLU module along with the input textual information to generate a cognitive model of the text. FIG. 3 illustrates a model generation architecture. Textual information 302 becomes input to the NLU module at step 306. The output of the NLU module is a cognitive model 308 in FOL. The cognitive model and the textual information are connected by the concept index 306 which locates the concepts in the cognitive model in the original text for display. Notice that disambiguated, interpreted concepts from the meaning and content of the text are remembered, rather than the word patterns (strings) which are indexed in keyword-based text retrieval.

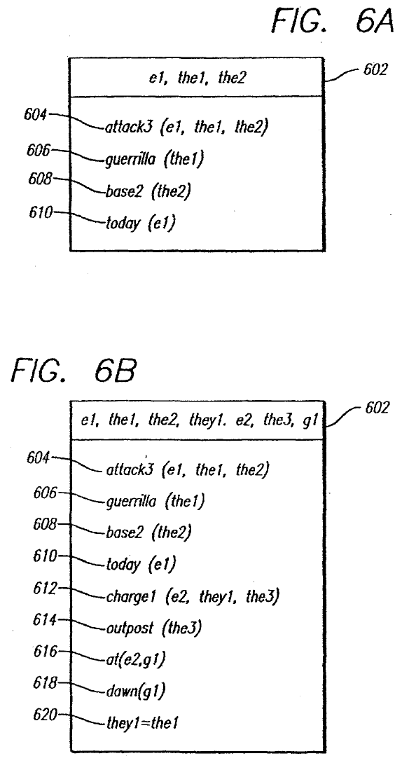

The concept index 306 is used in the second process to retrieve text. FIG. 4 provides an illustration of a Text Retrieval Architecture. Preferably, a search takes place in two passes. The first pass, a high recall statistical retrieval, locates a “long list” of relevant documents. Instead of basing the statistical approach on the words in the text, the statistics can be based on the disambiguated concepts that appear in the text. The second pass, a relevance reasoning pass, refines the “long list” to produce a “short list” of selected texts that are truly relevant to the query.

The flow of processing begins with a query or search request that is stated in a natural language (e.g., English) at step 402. The query is input the NLU module at step 404. The NLU module generates a cognitive model of the query at step 406. At step 408, the High Recall Statistical Retrieval (HRSR) Module applies statistical methods in parallel to the concept index to produce the “long list” of relevant texts. The HRSR Module applies a loose filtering mechanism, for example, to find all of the relevant texts (and potentially some irrelevant ones). At step 410, the “long list” becomes the input to the second pass performed by the Relevance Reasoning (RR) Module that refines the “long list”. At step 412, the RR selects the truly relevant texts from the “long list”. The entire cognitive model of each text in the “long list” is brought into memory and compared with the cognitive model of the query. The RR module applies FOL theorem-proving and human-like reasoning. The output, at step 414, is a “short list” that identifies all of the text that is relevant to the query. At step 416, the “short list” can be used to generate windows that include, for example, the “short list” and a display of the relevant text. At step 418, one or more such windows are displayed for review by the search requester.

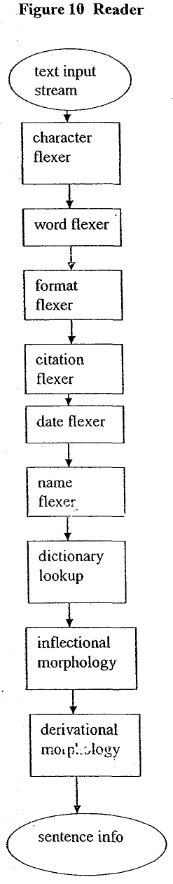

An improved embodiment will now be described with reference to FIGS. 9a and on.

Referring now to FIG. 9a, a flow chart illustrating an improved natural language understanding unit (NLU) 9-10 which may be used for indexing documents to provide a searchable index of the documents. NLU 910, or portions thereof may then be used for providing a query in the same format as the searchable index to permit retrieval of the documents related to the query. A natural language approach is used for producing the searchable index and the searchable query which breaks up the text or query into words, dates, names, places and sentences. The result of the reader is parsed to identify lexicalized phrases such as “bok choy” and “kick the bucket”. The parsed words, phrases and sentences are then analyzed to retrieve word stems. Finally, the senses of the parsed words, sentences and word stems are processed to identify which of the multiple meanings of ambiguous stems were intended in the test or query. During indexing, synonyms and hypernyms for the text contents are added. As a result, searchable concept and string indexes in a specialized format including synonyms and hypemyms are associated with the text. The indexes can be searched by queries in a similar specialized format, except without synonyms and hypernyms, to retrieve the relevant text.

In particular, NLU 9-38 includes text or query input 9-12, reader 9-14, phrase parser 9-16, morphological component 9-18, and sense selector 9-20 which produces test meaning output 9-22. When NLU 9-10 is used for indexing, text meaning 9-22 is applied to synonym and hypernym module 9-24, the output of which may be applied to compression module 9-26 the output of which may be applied to concept index 9-28 and string index 9-30. These modules utilize static syntactic and semantic databases such as dictionary and ontology database 9-32 which, in one embodiment, may include 350,000 word stems, the syntactic properties of those stems, all of their senses for a total of 370,000 senses, syntactic information for each sense, if they differ in syntactic information, at least one ontological attachment for each sense and possibly additional attachments for a total of 6,000 nodes in the ontology, and naive semantic information for each sense, a concept thesaurus database 9-36 which include concept groups of senses of words and phrases, sense context database 9-34 which is used for deriving contexts for word meanings, i.e. concepts.

As described below in greater detail, reader 9-14 takes text from documents to be indexed or queries 9-12 and breaks it into words, dates, names and places, introducing valuable linguistic information from the dictionary at the same time. Thus reader 9-14 determines that a first sample text input
“The suit in U.S. court was stopped by res judicata.”
   consists of the sentence
“The suit in U.S. court was stopped by res judicata.”
   and includes the words
“the”, “suit”, “in”, “U.S.”, “court”, “was”, “stopped”, “by” “res” and “judicata”.
   While a second sample text input
“Mr. Xang Xi visited the U.S. He started in New York City.”,
   consists of two sentences,
“Mr. Xang Xi visited the U.S.”,
   and
“He started in New York City.”
   The first sentence includes the words and a name with first name “Xang” and last name “Xi”
“Mr.-Xang-Xi”, “visited”, “the”, and “U.S.”,
   and the second sentence includes the words and place
“he”, “started”, “in”, “New-York-City”.

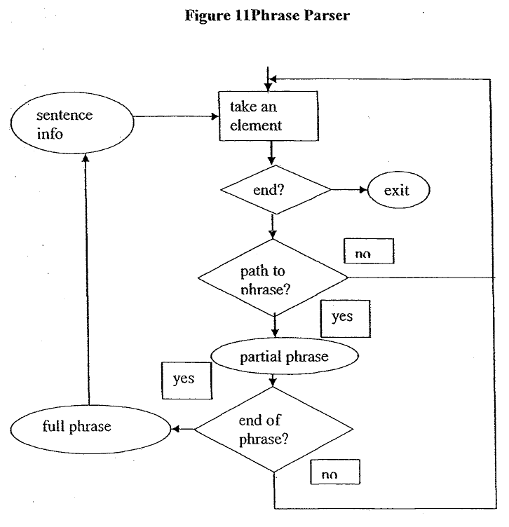

Reader 9-14 determines sentence and word boundaries as described above and provides the sentences, words, names, places and dates associated with the sentences as outputs to phrase parser 9-16. It is important to note that reader 9-14 accurately identified “U.S.” as both a word and in one instance in the first sample phrase as a sentence boundary. The method operation reader 9-14 uses to determine sentence boundaries is discussed in greater detail below with respect to FIG. 10.

Phrase parser 9-18 takes the output of the reader and identifies any lexicalized phrases, such as “res judicata”, “bok choy” or “kick the bucket”. In the sample texts described above, parser 9-16 would identify the phrase “res-judicata”. The output of parser 9-16 might therefore be the initial sentence representations of:
“the”, “suit”, “in”, “U.S.”, “court”, “was”, “stopped”, “by” “resjudicata”.
“Mr.-Xang-Xi”, “visited”, “the”, and “U.S.”
“he”, “started”, “in”, “New-York-City”.

Parser 9-16 may therefore be used to find lexicalized phrases such as “res-judicata” which is stored in the lexicon database 9-32.

The output of parser 9-16 is applied to morphology module 9-18 which may identify the basic stems of the words as processed, after recognizing regular and irregular prefixes and affixes. Morphology module 9-18 notices inflectional morphology as in baby-babies, and ring-rang-rung as well as derivational morphology as in “determine”, “determination”, “redetermination”. In these examples “baby”, “ring” and “determine” are the desired stems. Similarly, the past and future tenses of words are determined, so that “determined” can be represented as “determine, (past)”. So the morphology output of morphology unit 9-18 for the sample texts could become:
“the”, “suit”, “in”, “U.S.”, “court”, “be”, (past) “stop”, (past) “by” “res-judicata”.
“Mr.-Xang-Xi”, “visit”, (past) “the”, and “U.S.”
“he”, “start”, (past), “in”, “New-York-City”.

The sense selector 9-10 takes the output of the morphology component 9-18 and determines the meanings of the words in context using the sense contexts database 9-34. Thus in “furry bat”, the meaning of “bat” that is an animal is selected because of the context with “furry”, while in “baseball bat”, the meaning of “bat” that is a piece of sporting equipment is selected. So our examples become:
“the”, “suit3”, “in”, “U.S.”, “court4”, “be”, (past) “stop1”, (past) “by” “res-judicata”.
“Mr.-Xang-Xi”, “visit1”, (past) “the”, and “U.S.”
“he”, “start2”, (past) “in”, “New-York-City”
   where the indices mark sentences of ambiguous words. That is, “suit3” may be the third listed meaning of the word “suit” in the lexicon database 9-32 in which the first meaning may refer to suits of clothes, the second meaning may refer to the suitability of a selection while the third meaning refers to law suits. The output of sense selector 9-22 is text meaning 9-22 which is the appropriate output for a query input applied to input 9-12. The output for a text input to input 9-12 requires further processing to provide an index. An index may be provided for a single document, a large collection of documents or any other source to be searched by a query as will be described below in greater detail with regard to FIG. 9b.

When text meaning output 9-22 is to be indexed, it is first applied to synonym and hypernym module 9-24 and all non-content words may be stripped. The synonym and hypernyms for a substantial number of words are stored in concept thesaurus 9-36. The synonyms and hypernyms of each content word are identified by comparison with concept thesaurus database 9-36 and included in the representation output from synonym and hypemym module 9-24. For example, “res-judicata” may be represented as its synonym class r542, and “visit” is represented as its synonym class r999, etc. That is, concept thesaurus 9-36 may include a synonym class r542 which includes both the words “resjudicata” and “stare decisis” as well as other words which connote the legal principal that a prior decision should be binding on future decisions.

In addition, by comparison of the words and phrases in text meaning 9-22 with lexicon database 9-32, the parents or mothers of each word may also be, for example, New-York-City synonym class r30333 includes the mothers “city” and “complex”.
r666,r403,r606,r692,r452,past
Mr.-Xang-Xi, r999,r403,past
r530,r462,r30333,past

The indexer produces a concept index 9-28 and a string index 9-30. The concept index 9-28 indicates where in the document being indexed, each concept (including synonyms and hypemyms) occurs, as below:
r666-bytes 0-100
r403, bytes 0-100, and 101-172
r530, bytes 173-225
   etc. For example, the concept r666 as listed in concept thesaurus database 9-36 can be found between bytes 0 and 100 in the document to be indexed.

String index 9-30 indicates where in the document being indexed, each phrase, name, place or date identified by parser occurs and includes. The concept and string indices are used for searching.

It is important to note that the linguistic reasoning is compiled into the index, so that at search time when the query is compared to the indexes of one or more documents, no reasoning about synonyms or hypernyms is necessary. It is also important to note that the linguistic reasoning is applied during indexing, which can be accomplished off line, and not during querying in order to avoid the explosion of words to be searched. If this not done, there can be a combinatorial explosion in the reasoning with the ontology. It could take minutes to reason around in the ontology on each query, only to find that no children of a search term actually existed in the document base. By compiling that information, and the thesaural reasoning, negligible additional time is needed to search MMT's sophisticated conceptual index of a document base over the time it would take to search a pattern-based index.

Referring now to FIG. 9b, search system 9-38 is shown which includes indexing engine 9-40 and search engine 9-42. In overview, system 9-38 uses indexing engine 9-40 to develop indexes for each of a series of data sources making up a textual database, such as documents produced by a defendant in litigation and then uses search engine 9-42 to process queries or searches to display the documents, and portions of documents, in the textual data base relevant to the search.

In particular in indexing engine 9-40, the textual data base 9-12 applied as an input to natural language processor (NLP) 9-44 may include any number or type of documents to be processed. NLP 9-42 includes reader 9-14, parser 9-16, morphology module 9-18, sense selector 9-20, synonym and hypernym processor 9-20 and indexer 9-26 as shown in FIG. 9a. Concept thesaurus 9-36 and lexicon 9-32 are applied as inputs to NLP 9-42 and concept and string indexes 9-28 and 9-32 are produced by NLP 9-42.

In search engine 9-42, a search request or query 9-12 is applied to NLP 9-46 which differs from NLP 9-44 in indexing engine 9-40. In particular, NLP 9-46 may include reader 9-14, parser 9-16, morphology module 9-18 and sense selector 9-20 but not synonym and hypernym processor 9-20 and indexer 9-26, all as shown in FIG. 9a. That is, the output of NLP 9-46 is text meaning output 9-22 which is a representation in concept form of the original query 9-12. It is important to note that synonym and hypernym module 9-24, shown in FIG. 9A is used in the NLP of indexing engine 9-40 but not in search engine 9-42. This configuration substantially improves the real time performance of NLU search system 9-38 by avoiding the “explosion” of terms to be searched resulting from inclusion of synonym and hypernym processing in the query engine of previous systems including the prior embodiment described above with respect to FIGS. 1-8.

Text meaning output 9-22, which represents the concepts and words in query 9-18, is applied to concept matcher 9-48 which locates, via concept index 9-28 and string index 9-30, where in textual data base 9-11 the requested words and concepts may be found. The string index provides a backup to conceptual searching. In case a query term is not known to the lexicon, it can still be found if it exists in the document base by searching in the string index. These locations in textual database 9-11 may be retrieved and displayed on computer monitor 9-50 or by other convenient means.

The preparation of an index for the first sample text “The suit in U.S. court was stopped by res judicata.” may be as follows:
Text Input 9-12:
   “The suit in U.S. court was stopped by res judicata.”
Reader 9-14 sentence processing
   “The suit in U.S. court was stopped by res judicata.”
Reader 9-14 word processing
   “the”, “suit”, “in”, “U.S.”, court, “was”, “stopped”, “by” “res” and “judicata”
Reader 9-14 output applied to Parser 9-16
   “The suit in U.S. court was stopped by res judicata.”
   “the”, suit”, in, “U.S.”, court, “was”, “stopped”, “by” “res” and “judicata”
Parser Output
   “the”, “suit”, “in”, “U.S.”, court, “was”, “stopped”, “by” “res-judicata”
Morphology 9-18 Processing
   “was” is the past tense of “be”, replace “was” with “be”, past
Morphology 9-18 output applied to Sense Selector 9-20
   “the”, “suit”, “in”, “U.S.”, court, “be”, “stop”, past, “by” “resjudicata”.
Sense Selector 9-20
   “suit” is used in the context of litigation, replace with “suit3”
   “court” is used in the context of litigation, replace with “court4”
   “stopped” is the past tense of one meaning of “stop”, replace with “stop1”
Text meaning 9-22
   “the”, “suit3”, “in”, “U.S.”, court4, “be”, (past) “stop1”, “by” “res-judicata”.
Index 9-24 processing
   1. Remove words without content
      “suit3”, “U.S.”, court4, (past) “stop1”, “res-judicata”
   2. Determine synonym and hypemym classes
      “suit3” is class r666,
      “court4” is class
   3. Replace words with classes.
      r666, r403, r606, r692, r452,past
         Concept Index 9-28 Contents

Concept Index 9-28 contains, for each concept ID that occurred in document base, all of that concept ID's hypernyms (e.g. for the word sense “dog1”, hypemyms “canine”, “mammal”, “vertebrate”, etc.), and the document ID's it occurred in, and for each document ID, the locations of each occurrence in the document represented as a displacement from the beginning of the document.

String Index 9-30 Contents

String Index 9-30 contains, for each string that occurred in document base, the string itself and the document ID's that string occurred in, and for each document ID, the locations of each occurrence in the document represented as a displacement from the beginning of the document.

The preparation of a index for the second sample text “Mr. Xang Xi visited the U.S. He started in New York City” may be as follows:

Reader

Referring now to FIG. 10, the reader processes all of the raw input coming into the system, whether for text indexing or query processing.
The purposes of the reader are:
   1. to carve up text correctly into
      a. words
      b. sentences
      c. paragraphs
      d. sections with headings
   2. to recognize fixed or semi-fixed expressions of
      a. time
      b. date
      c. location
   3. to correctly recognize patterns such as
      a. numerical expressions
      b. abbreviations
      c. legal citations
   4. to recognize, track, and co-identify human names
   5. to look up words in the dictionary and identify all of the possible words and word meanings corresponding to a given string, ruling out those that are NOT possible before they are passed to the sense selector. For example, if an inflected verb form is used, the reader rules out any noun-only senses of that word.

The reader employs a cascade of flex modules. Each flexer contains a series of patterns (encoded regular expressions) and associated actions that are taken if the pattern is matched.

The input to the lowest module is a text stream, coming either from a text being indexed or from a user's search string. The output from the highest module is a string containing information about all of the possible words and senses for a given input string. This includes dictionary handles, as well as “control” elements carrying additional information such as punctuation, capitalization, and formatting. This output string is then used to populate a “SentenceInfo” structure which is used as the input for further processing.

The input for all but the first flex module in the cascade is the output of the previous flex module. The cascade of flexers is as follows:
character
word
format
citation
date
name
lookup

Morphological processing is done with an additional three flex modules: one for processing inflected forms, one for matching derivational prefixes, and one for matching derivational suffixes. The input to the inflectional morphology flexer is set within a function in the lookup flexer, and the input to the flex modules for derivational morphology is set by a function in the inflectional morphology flexer.

Derivational Morphology

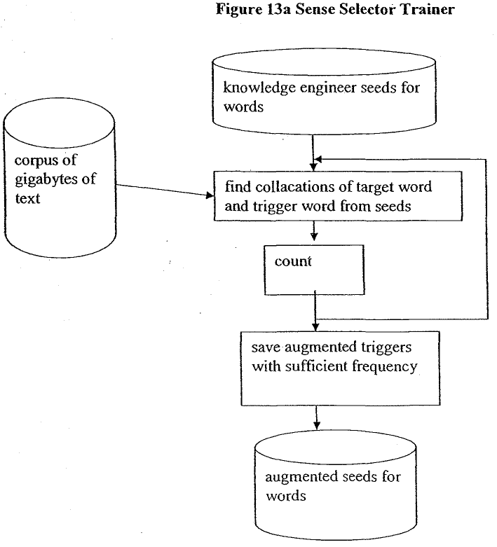

Referring now to FIGS. 10 and 12, the derivational morphology (DM) module is responsible for recognizing words not found in the dictionary by combining known words with productive derivational affixes. The productive affixes are those for which it is possible to construct new words.

The DM module is employed only when no entry for the word can be found in the dictionary, modulo inflection. Any derived word with non-compositional meaning or unpredictable syntactic properties must be entered into the dictionary, since the DM module cannot assign the correct representation to such words. Frequently occurring derived words, such as “reread”, are also likely to be found in the dictionary.

The input string is fed first to a function which attempts to parse it into sequences of prefixes, suffixes, and word stems. The string is scanned first by the derivational prefix flexer (reader_dpre.flex), and then by the derivation suffix flexer (reader_dsuf.flex). Since combinations of suffixes can result in phonological alternation within the suffix, the suffix flexer includes patterns for these forms as well. Before stems are looked up, functions that reverse the effect of phonological alternation are applied. The new stems are added to the array of stems to be looked up.

Each parse found is then analyzed to determine whether that combination of affixes and stem is good. This is done by checking features of each affix+stem combination to make sure that they are compatible. Each affix has conditions on the syntactic and semantic features of the stem it combines with, as well as a specification of the syntactic and semantic features of the resulting combination. The features examined may include syntactic category and subcategory and/or ontological ancestor.

If an analysis is successful, a new word structure is built and the new word is added to the dynamic dictionary. The features of the derived word may include syntactic category, ontological attachment, and/or naive semantic features. Unless the affix in question is marked “norac” to suppress it, the word that the affix attached to is added as a feature so that the base word is indexed along with the derived word.

Phrase Parser

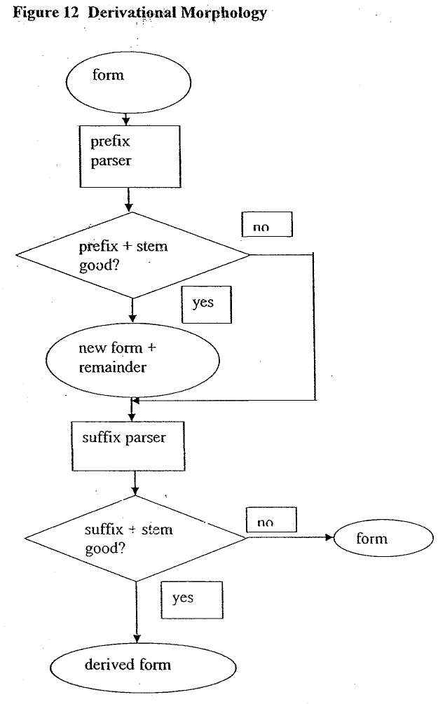

Referring now to FIG. 11, the function of the phrase parser is to recognize phrases encoded in the dictionary.

Phrases are not given full entries in the dictionary, since that would make the dictionary larger and dictionary lookup slower. Instead, the entry for each phrase is encoded as a sense of the final word in the phrase. Within the compressed dictionary, a finite state machine encodes each phrase. Each word in the phrase is a path to the next state. Final states represent completed phrases.

The phrase module is responsible for traversing the phrase FSM to identify the phrases within a sentence. The input to the phrase module is a filled-in SentenceInfo structure containing all of the possible words and stems for a given sentence, along with the information supplied by control elements.

The phrase module employs a function which is called with each element in the SentenceInfo word array as a potential starting point for a phrase.

Each element of the SentenceInfo word array is first examined to see if it is a lexical element or a control element.

Control elements are examined to see whether they can be safely ignored or whether they are elements which should cause the phrase to fail. For example, a comma between two elements of a phrase would cause this function to return without recognizing the phrase, whereas a control element indicating the start of a capitalized sequence would not.

If the element is lexical, it is then looked up in the Phrase FSM encoded in the dictionary to determine whether it represents a path to some state in the FSM. If such a state exists, it is further examined to determine whether it is a “final” state, in which case the dictionary handle corresponding to the completed phrase is returned. If the state found is not a final one, the function is called recursively, with the phrase's starting position recorded and the current position incremented.

If a state is found to be a final state, the inflectional features of the final word of the phrase are examined to see if they are consistent with the morphological features of the phrase. For example, if the input sentence is “This hat makes my head colder”, the phrase “head-cold” will be rejected because the phrase, a noun, does not admit comparative inflection.

Once a completed phrase has been found, it is added into the SentenceInfo. The sentence position it occupies is the same as the final word of the phrase, and the position of the first word of the phrase is recorded within the SentenceInfo entry.

Sense Selector

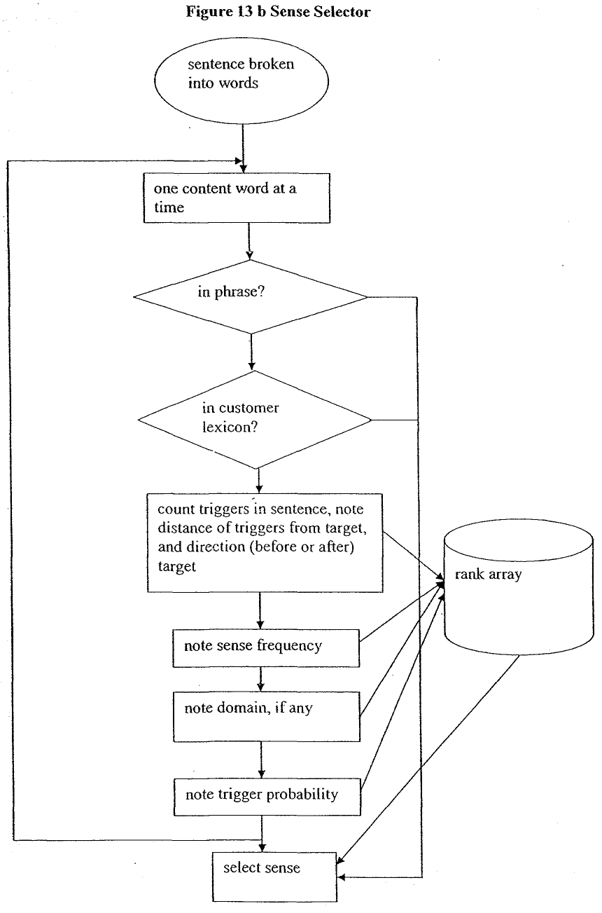

Referring now to FIGS. 13a and 13b, the goal of the sense selector is to automatically assign a sense to an ambiguous word inspecting the other words around it in the sentence. For example, in “furry bat”, “bat” is interpreted as an animal, but in “baseball bat”, bat is interpreted as a piece of sporting equipment.

The first task is to build a semantic database of sense-disambiguated environments. To that end linguists work with a “Seeder Tool”. Contexts (or collocations) for each ambiguous word are found by scanning a 600 megabyte corpus of English text. These collocations are displayed for the linguist, with the target word highlighted at the center. The linguist clicks on the word that most influences the sense choice of the target word, selecting a “trigger word”. The trigger word's senses are displayed from the dictionary entry, so that the linguist can select the desired sense of the trigger word. Likewise target word's senses are displayed for selection. As a result a file is produced, the .sds file, containing the target word, its morphology, and trigger lines. Each line includes the selected senses of both the target and trigger, the distance between them (both forward and backward) and the trigger stem.

The second step, the training step, is to augment the linguist triggers with additional triggers through boot-strapping. The “trainer” muddle searches the corpus for sentences that contain both the target and trigger words, and it is assumed that the target has the chosen sense in that sentence. Then other words in the sentence are proposed as additional triggers. If a sufficient number of sentences in the corpus are found with the target and the proposed new trigger, the proposed trigger is taken to be a true indicator of the chosen target sense, originally chosen by a linguist, but not for the environment of the new trigger. In addition, all the children of the mother of each linguist-assigned trigger are proposed as triggers and checked for frequency in the corpus. In other words, all the sisters of the linguist-assigned triggers are proposed. A new file is created, the decision file, which has trigger lines for all the linguist-assigned triggers as well as the augmented triggers.

The .decision file indicates for each trigger line whether it was linguist-assigned, and if not, the probability that the trigger is indeed a trigger. It also indicates the distance between the 2 words.

This seed database is compressed and encrypted in the “seed library”.

At sentence interpretation time, the “sense selector” module inspects the surround of each ambiguous word in the sentence, and attempts to find triggers for the ambiguous word.

Factors in sense selection:
1. sense membership in phrase
2. customer sense selection
3. # of triggers
4. distance of trigger from target
5. sense frequency
6. domain, if any
7. trigger probability

At the end of sentence processing, the sense with the highest ranking is selected for each word.

Hypernym and Synonym Analyzer

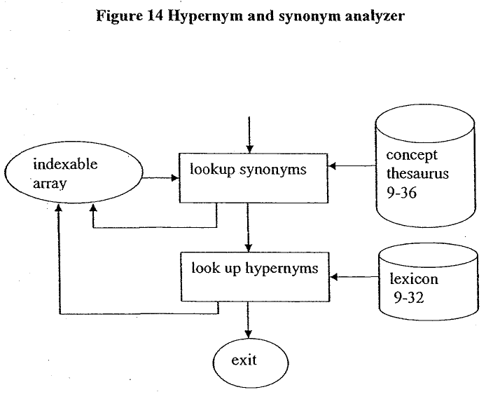

Referring now to FIG. 14, after all the sentence and word processing, and removal of non-contents, the word senses and phrases to be indexed and recorded are stored in the “indexable” array. This array is augmented by synonyms and hypernyms so that the concept classes and hypemyrnms of sense or phrase are present in the index, removing the necessity and costly delay of reasoning to discover synonyms and hypernyms at search time. Each indexable word or phrase is looked up in the concept thesaurus 9-36 and all concept classes are added to the indexable array. Then all hypernyms of the sense or phrase are looked up in the lexicon 9-32 and those are added to the indexable array. The concept classes and hypernyms are stored in the concept index, and the words and phrases are stored in the string index.

Lexicon Database 9-32

The lexicon is similar to the one described in the original patent, although much larger. It now has approximately 350,000 stems, 370,000 concepts, 6,000 ontological nodes and 99,000 phrases. Phrase handling is new since the 1998 patent. Phrases are encoded in the dictionary as a prefix-tree finite state automaton. Each word in the dictionary contains a list of the <source-state, destination-state> pairs corresponding to the edges that word labels in the automaton. The dictionary entry for the phrase itself is accessible by a special entry corresponding to the accepting state for that phrase within the automaton.

Concept Thesaurus Database 9-36

The Meaning Seeker concept thesaurus 9-36 provides a way of co-associating word senses, nodes, and phrases. Each thesaural group thus represents (loosely) a single concept. The elements of each group may contain senses of words or phrases in any syntactic category. The search engine employs a unique integer assigned to each thesaural group in indexing and retrieval.

Thesaural groups may include ontological nodes, which allows the search engine to reason across thesaural cohorts and down to the descendants of the node. For example, a query on “workout” would retrieve to “hike”, not because it is in the same thesaural group, but because its ancestor is.
thesaural {workout, EXERCISE_EVENT, work6, physical-activity, . . . }
group
descendants [hike, constitutional3, jog, run, row2, . . . ]
of
exercise_event
node
   Semantic Database Updating

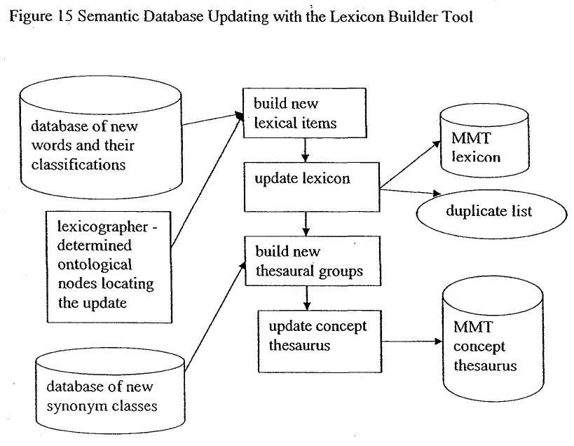

Referring now to FIG. 15, now that the MMT Lexicon has 370,000 concepts, 350,000 words and 99,000 phrases, it covers almost all of English except very technical sub-domains such as metallurgy, pharmacology and corporation-specific widget and brand names. There are 6,000 nodes in the MMT ontology, and over 40,000 concept thesaurus groups or entries. MMT has developed tools to automatically induce and incorporate new lexical items into the ontology and concept thesaurus. There are two sources of such information. One source is derived from digitized catalogs, or digitized classification schemes for vocabulary provided to MMT by corporations, or available on the web. A Lexicon Builder programs reads these digitized sources and automatically builds lexical items and thesaural groups for them. Typically there is a preliminary step in which a lexicographer inspects the classification scheme and decides where in the MMT ontology to insert the new nodes. Then the Lexicon Builder program automatically builds out the new ontology from those nodes. Any words already existent in the MMT lexicon are hand-inspected from a list generated by the program to ensure that senses are not duplicated.

The other source of such information is the World Wide Web. There are a number of sites devoted to domain vocabulary. In order to build the lexicon from such a source, first the site is crawled using the MMT spider and the information is stored in a local database. Then a lexicographer inspects the vocabulary to determine where in the existing ontology it should be inserted. The Lexicon Builder program is run over the database of new lexical items, their categories and their synonyms. Again, any words already existent in the MMT lexicon are hand-inspected from a list generated by the program to ensure that senses are not duplicated.

The Lexicon Builder program takes input drawn from a classification scheme or from a domain dictionary on the World Wide Web, and for each term or phrase, determines if the word or phrase is already in the lexicon. If it is, it outputs the word or phrase to the duplicates list for lexicographer inspection. If it is not, it builds a new lexical item and updates the lexicon with it, giving it a definition and ontological attachment, and a domain feature if relevant. Then it takes synonym information and creates a new concept class for the synonyms, and adds that to the concept thesaurus.

We claim:

1. A method of searching a collection a database of documents, comprising:
providing a natural language understanding (NLU) module which parses text and disambiguates the parsed text using a naive semantic lexicon providing an ontology aspect to classify concepts and a descriptive aspect to identify properties of the concept;
processing documents in a database with the NLU module to generate cognitive models of each of documents and a searchable index of the cognitive models in a predetermined format indicating the possible, non-ambiguous meanings of the concepts together with synonyms and hypemyms of the concepts by selection from a precompiled static dictionary and ontology database;
processing a query with the NLU module to generate a cognitive model of the query in the predetermined format without synonyms and hypernyms;
comparing the cognitive model of the query with the searchable index to select the documents likely to be relevant to the query; and
comparing the cognitive model of the query with the full text of the selected documents to select the documents to include in a response to the query.
